(19) United States
(12) Patent Application Publication
(10) Pub. No.: US 2020/0407244 A1
(43) Pub. Date: Dec. 31, 2020

(54) METHODS FOR PRODUCING A FOOD PRODUCT

(71) Applicant: Bunge North America, Inc., Chesterfield, MO (US)

(72) Inventors: Shawn Pan, Creve Coeur, MO (US); Brian Anderson, Chesterfield, MO (US); Jake Schneider, St. Louis, MO (US)

(21) Appl. No.: 16/633,920

(22) PCT Filed: Jul. 23, 2018
(86) PCT No.: PCT/US2018/043270

§ 371 Date: Jan. 24, 2020

Related U.S. Application Data
(60) Provisional application No. 62/536,115, filed on Jul. 24, 2017.

(51) Int. Cl. C02F 1/44; C02F 1/66; A23L 7/10

(52) U.S. Cl. CPC C02F 1/444; C02F 1/66; C02F 2101/345; B01D 2321/162; B01D 2311/18; A23L 7/1975

(57) ABSTRACT

Methods for producing a food product that involve use of a cross-flow filtration module are disclosed. The cross-flow filtration module may be used to recycle wastewater effluent and/or to recover antioxidant compounds from the wastewater effluent. In some embodiments, the cross-flow filtration module includes a stainless steel or nickel alloy substrate.

### CROSS-REFERENCE TO RELATED APPLICATION

This application claims the benefit of U.S. Provisional Patent Application No. 62/536,115, filed Jul. 24, 2017, which is incorporated herein by reference in its entirety.

### FIELD OF THE DISCLOSURE

The field of the disclosure relates to methods for producing a food product and, in particular, methods that involve use of a cross-flow filtration module to recycle wastewater effluent and/or to recover antioxidant compounds from the wastewater effluent.

### BACKGROUND

Nixtamalization processing of grains by alkaline cooking is conventionally used to produce hominy. Hominy may be used as a food product or hominy may be ground to form masa either in the form of dried flour or wet dough. Alkaline (e.g., lime) cooking uses a substantial amount of water, both for cooking of the grain and for washing of the grain after cooking. The wastewater effluent (commonly referred to as “nejayote”) is discarded which requires costly treatment before disposal into the environment.

A need exists for methods for producing food products such as masa that allow the wastewater effluent produced during processing to be recycled and/or that allow compounds to be recovered from the wastewater effluent for further use.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a method for producing a food product from a cereal grain. The cereal grain is introduced into an alkaline cooking system to contact the cereal grain with an alkaline solution to partially hydrolyze the cereal grain. The partially hydrolyzed cereal grain is dewatered in a dewatering system to form a food precursor and a wastewater effluent. The food precursor is processed to form a food product. The wastewater effluent is introduced into a cross-flow filtration module to produce a permeate. The permeate is depleted in impurities relative to the effluent. At least a portion of the permeate is introduced into (1) the alkaline cooking system for partially hydrolyzing the cereal grain and/or (2) the dewatering system for dewatering the partially hydrolyzed cereal grain.

Another aspect of the present disclosure is directed to a method for recovering antioxidants from a wastewater effluent. The wastewater effluent is a by-product of the alkaline hydrolysis of a cereal grain. The wastewater effluent is introduced into a cross-flow filtration module. The cross-flow filtration module includes a porous filtration membrane which retains a portion of the effluent as retentate and allows a portion of the effluent to pass through the filtration membrane as permeate. The retentate or permeate is enriched in antioxidants relative to the wastewater effluent. The antioxidant compounds are extracted from the permeate or from the retentate.

Yet another aspect of the present disclosure is directed to a method for producing a food product and an antioxidant composition from a cereal grain. The cereal grain is contacted with an alkaline solution to partially hydrolyze the cereal grain. The partially hydrolyzed cereal graM is dewatered to form a food precursor and a wastewater effluent. The food precursor is processed to form a food product. The wastewater effluent is introduced into a filtration module to concentrate antioxidants in a permeate or retentate. At least a portion of the permeate is recycled to produce the food product and the antioxidant composition.

In yet a further aspect, the present disclosure is directed to the antioxidants, or a composition comprising the antioxidants, which is obtained from one or more of the methods described herein and above.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a flow diagram of a method for processing a cereal grain to produce a food product that includes a cross-flow filtration module and permeate recycle;

FIG. 2 is a flow diagram of a method for processing a cereal grain that includes pH adjustment after filtration;

FIG. 3 is a flow diagram of a method for processing a cereal grain that includes impurity removal after filtration;

FIG. 4 is a flow diagram of a method for processing a cereal grain that includes antioxidant recovery from a permeate of a cross-flow filtration module;

FIG. 5 is a flow diagram of a method for processing a cereal grain that includes antioxidant recovery from a retentate of a cross-flow filtration module;

FIG. 6 is a flow diagram of antioxidant recovery using absorption media;

FIG. 7 is a flow diagram of a method for processing a cereal grain that includes antioxidant recovery from a permeate of a cross-flow filtration module with permeate recycle;

FIG. 8 is a flow diagram of a method for processing a cereal grain that includes antioxidant recovery from a retentate of a cross-flow filtration module with permeate recycle;

FIG. 9 is a flow diagram of the pilot scale testing system of Example 1;

FIG. 10 is a graph of membrane flux as a function of time;

FIG. 11 is a flow diagram of the continuous testing system of Example 2;

FIG. 12 is a perspective view of a cross-flow filtration module; and

FIG. 13 is a side view of a filtration membrane tube.

Corresponding reference characters indicate corresponding parts throughout the drawings.

### DETAILED DESCRIPTION

Provisions of the present disclosure relate to methods for producing a food product from a cereal grain. A wastewater effluent generated during production of the food product is contacted with a cross-flow filtration module having a porous filtration membrane. The porous filtration membrane may include a substrate made of stainless steel or a nickel alloy with a sintered titanium dioxide coating bonded to the substrate.

While the methods of the present disclosure may be described with respect to production of masa from a cereal grain such as corn, the methods are applicable to production of any food product from a cereal grain unless stated otherwise. Other cereal grains which may be processed in accordance with embodiments of the present disclosure include, for example, wheat, rice, barley, sorghum, millet, rye, oats, teff, buckwheat, quinoa, and amaranth.

### Grain Processing

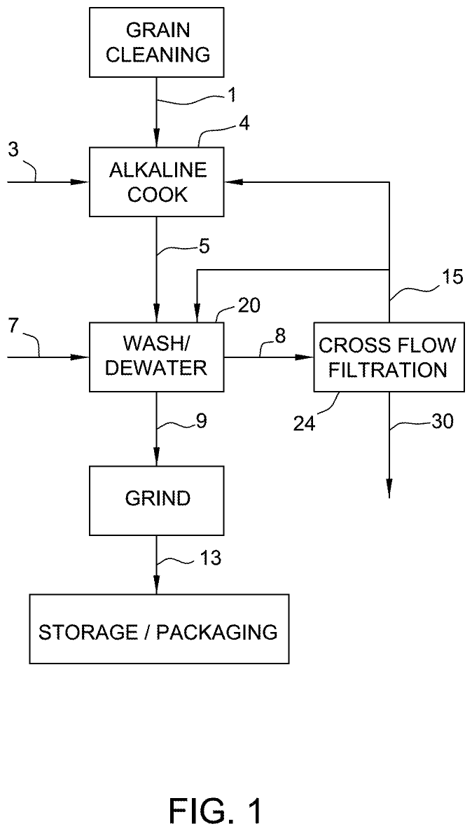

Referring now to FIG. 1, grain 1 is introduced into an alkaline cooking system 4 in which the grain is soaked in an alkaline solution 3 while heating. Prior to cooking, the grain 1 may be cleaned to remove foreign matter (e.g., by sifting, magnets or the like).

The pH and/or temperature at which the grain is cooked may vary depending on the type of grain and may be selected such that the cooked grain 5 is suitable for downstream dough formation and for digestion. In some embodiments of the present disclosure (e.g., in some embodiments in which corn is processed), the grain is cooked at a pH of 10.5 or more (e.g., 10.5, 11 or 11.5) and/or at a temperature of at least about 60° C. Whole kernels of grain may be cooked (e.g., without particle size reduction) with the ratio of alkaline and grain being controlled before and/or during the cooking process. The rates at which grain and alkaline are metered into the alkaline cooking system 4 may be controlled with a gravimetric feeder such as a “loss in weight feeder,” which may be referred to herein simply as a “macerator”. The cooking process partially hydrolyzes the cereal grain to soften the grain and make it suitable for dough formation and for digestion.

The cooked grain 5 is strained and/or dewatered in a dewatering system 20. Optionally, the dewatering system may include a wash system in which grain is contacted with wash water 7 and dewatered (e.g., wash screens or the like). The dewatering operation produces a wastewater effluent 8 that is removed from the dewatering system 20. The dewatered, cooked grain or “food precursor” 9 (e.g., nixtamal when corn is processed) is further processed to produce a food product. For example, the food precursor 9 may be ground to produce a food product 13. A hammermill may be used to grind the food precursor 9. The ground food product 13 (e.g., masa) may be further processed such as by drying into flour or by preparing a dough. The food product 13 may be stored and/or packaged.

### Wastewater Recycle

The wastewater effluent 8 from the dewatering system 20 is introduced into a cross flow filtration module 24. The effluent 8 introduced into the filtration module 24 may have a pH and/or temperature corresponding to the pH and/or temperature at which the grain was cooked. In some embodiments (e.g., some embodiments in which corn is processed) the wastewater effluent has a pH of about 10.5 or more (e.g., 10.5, 11 or 11.5).

In some embodiments, the pH of the wastewater effluent 8 is not modified between separation of the wastewater from the food precursor 9 in the dewatering system 20 and introduction into the cross-flow filtration module 24. The wastewater effluent 8 may be directly introduced into the cross-flow filtration module 24 after washing the partially hydrolyzed cereal grain 5 (e.g., without other processing such as temperature reduction, pH reduction, and the like). The wastewater effluent 8 may have a temperature of at least about 40° C. (e.g., 60° C. or more) when introduced into the module 24. The wastewater effluent 8 may optionally be cooled (e.g., by exchanging heat with another process stream) prior to filtration.

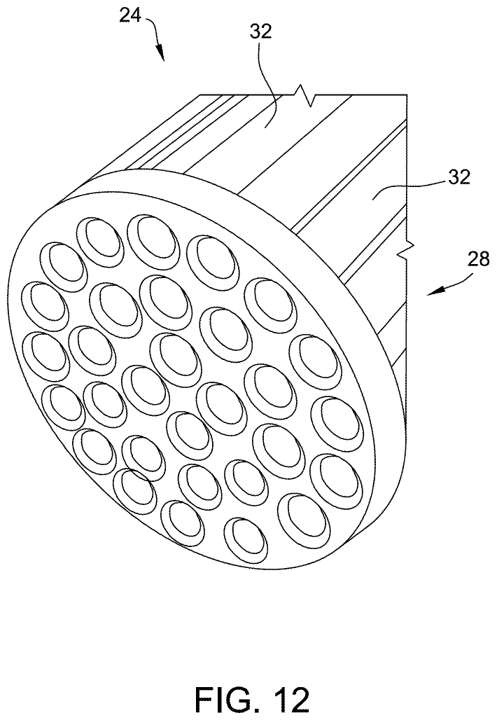

An example filtration module 24 is shown in FIG. 12. The cross-flow filtration module 24 includes a filtration membrane 28 which, in the illustrated embodiment, is a plurality of filtration membrane tubes 32. In some embodiments, the tubes 32 have an inner diameter from about 6 mm to about 25 mm. In other embodiments, the filtration membrane 28 has a non-tubular shape (e.g., may be planar).

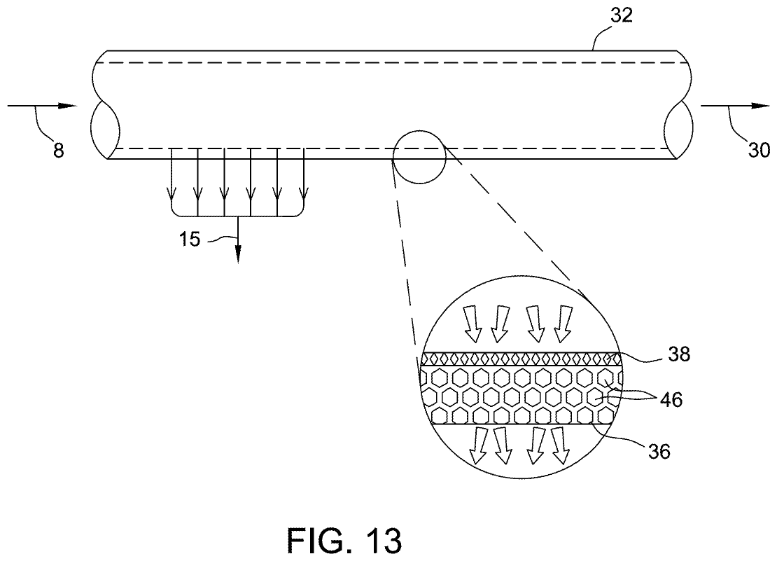

Referring now to FIG. 13, each porous filtration membrane tube 32 includes a substrate 36 that may be made of stainless steel (e.g., 316L) or a nickel alloy. The porous filtration membrane tube 32 may include a sintered titanium dioxide coating 38 bonded to the substrate 36.

The substrate 36 of the porous filtration membrane may be an agglomeration of irregularly shaped metal particles or subunits 46 that are formed into a tube (e.g., particles with a diameter less than 100 μm). Channels between particles 46 allow the substrate 36 to be porous and allow permeate 15 to pass through the substrate 36. To coat the tubular substrate 36 with titanium dioxide, the substrate 36 may be contacted with a slurry of titanium dioxide and sintered (e.g., heated to at least 900° C.). In some embodiments, the porous filtration membrane 28 (e.g., the porous membrane tubes 32) is a microfilter and/or includes pores having an average diameter of from about 0.1 μm to about 10 μm. In other embodiments, the porous filtration membrane 28 is an ultrafiltration membrane (e.g., with pores having an average diameter of from about 0.01 μm to about 0.1 μm) or even a nanofiltration membrane (e.g., with pores having an average diameter of from about 0.001 μm to about 0.01 μm).

The tubes 32 of the module 24 may be disposed within a permeate shell (not shown). The tubes 32 may be in a single-pass arrangement or a multi-pass arrangement. In multi-pass systems, subsets of tubes 32 may be connected in series. The modules 24 may be operated at pressures from about 150 psi to about 3,000 psi.

In some embodiments, the filtration membrane is stable at relatively high pH ranges such as a pH of about 10.5, about 11, about 11.5 or even a pH of 12 or more. For example, in various embodiments, the membrane will maintain its rigidity and/or will exhibit little to no signs of degradation or corrosion for an extended period of time, when exposed to these pH ranges. The filtration membrane may be stable at temperatures of about 60° C. or more (e.g., 150° C., 200° C., 300° C. or 350° C. or more).

Commercially available embodiments of cross-flow filtration membranes include Scepter® filters, available from Graver Technologies (Glasgow, Del.).

A permeate 15 passes through the filtration membrane 28. The permeate 15 is depleted in one or more impurities (e.g., suspended solids, dissolved solids, larger compounds, etc.) relative to the effluent 8 introduced into the cross-flow filtration module 24.

In some embodiments of the present disclosure and as shown in FIG. 1, at least a portion of the permeate 15 is recycled. For example, at least a portion of the permeate 15 may be introduced into the alkaline cooking system 4. Alternatively or in addition, at least a portion of the permeate is introduced into the dewatering system 20 (e.g., introduced into one or more wash units in the dewatering system to wash the cooked grain 5). A portion of the permeate 15 may also be discarded.

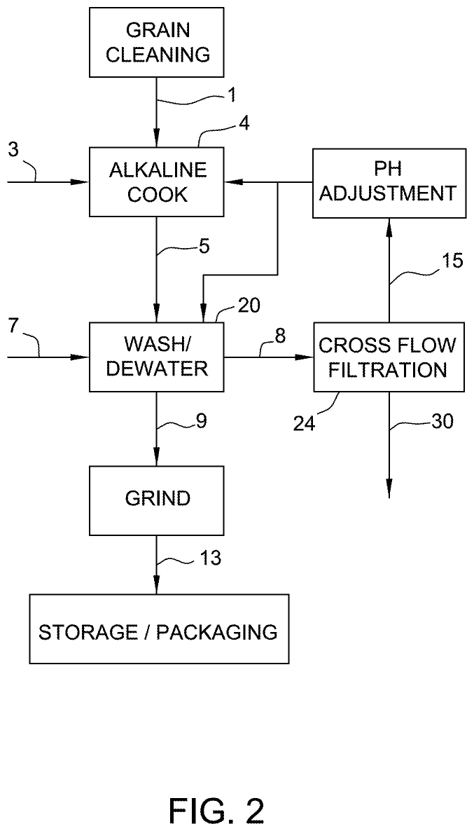

In some embodiments and as shown in FIG. 2, the pH of the permeate 15 may be reduced prior to introduction into the alkaline cook system 4 and/or the dewatering system 20. The pH of the permeate 15 may be reduced to less than 9, less than 8 or to a pH of about 7.

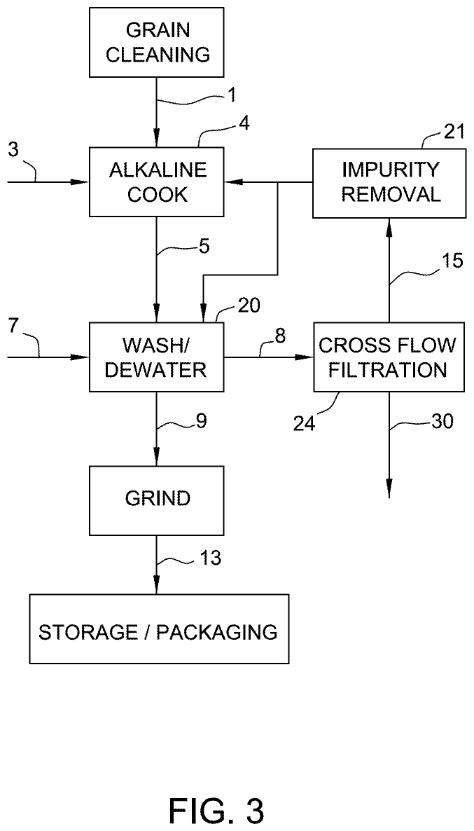

As shown in FIG. 3, the permeate 15 may be introduced into an impurity removal system 21 prior to introduction into the alkaline cook system 4 and/or the dewatering system 20 to remove at least a portion of impurities in the permeate. The permeate 15 may be contacted with activated carbon or resin material in the impurity removal system 21 to remove impurities from the permeate 15.

The retentate 30 (i.e., concentrate) that does not pass through the filtration membrane retains at least a portion of the impurities in the effluent (i.e., is concentrated in one or more impurities). The retentate 30 may be further processed to remove additional water and/or to concentrate dissolved or suspended solid materials, such as by evaporation. Retentate 30 may be enriched in starch, non-starch polysaccharides, and proteins relative to the wastewater effluent 8 and may be formulated in animal feeds or other suitable uses.

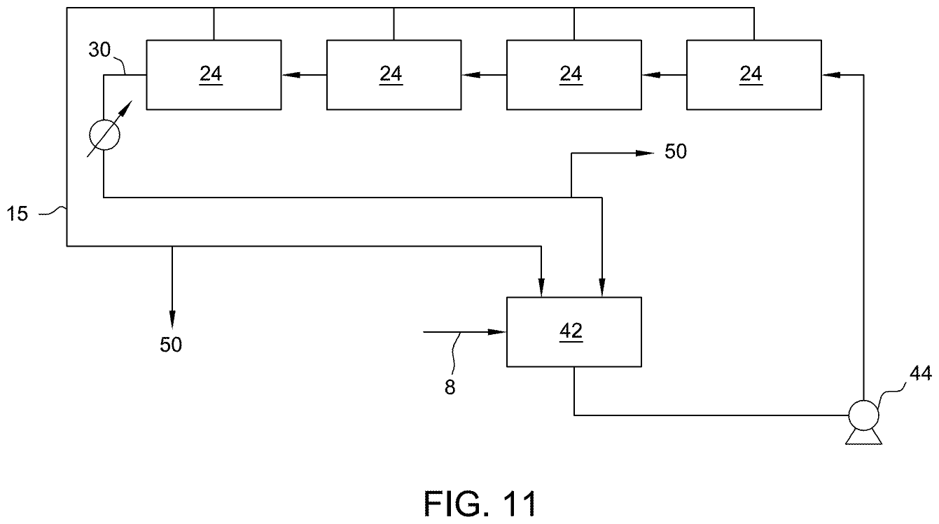

In some embodiments, the wastewater effluent 8 is introduced into a plurality of modules 24, either in parallel or in series. In one example (e.g., FIG. 11 of Example 2 below), the effluent is introduced into a first module with retentate from the first module being introduced into a second module. Optionally, the retentate from the second module may be introduced into one or more successive modules (e.g., three modules or four total modules 24 as shown in FIG. 11). Permeate 15 from the modules may be recycled by introducing at least a portion of the permeate 15 into the alkaline cook system 4 and/or the dewatering system 20. In this regard, reference herein to a filtration module 24 should be understood to include the optional use of multiple modules 24 connected in parallel or series unless stated otherwise.

### Antioxidant Recovery

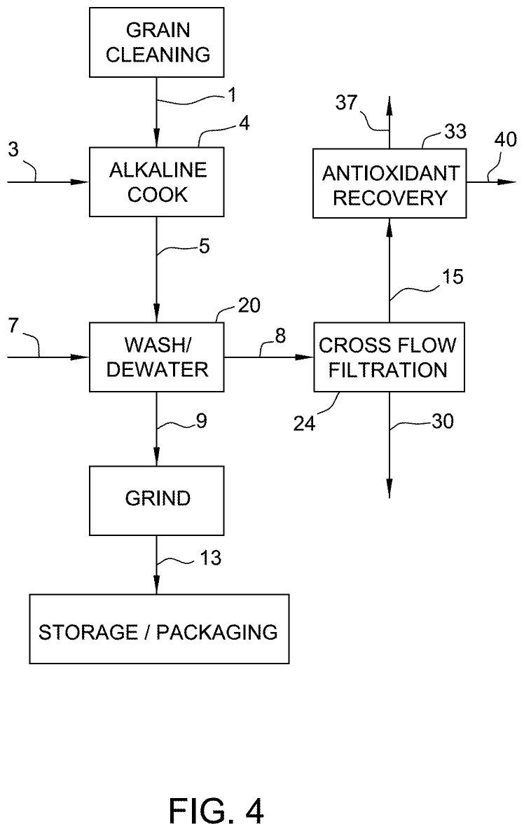

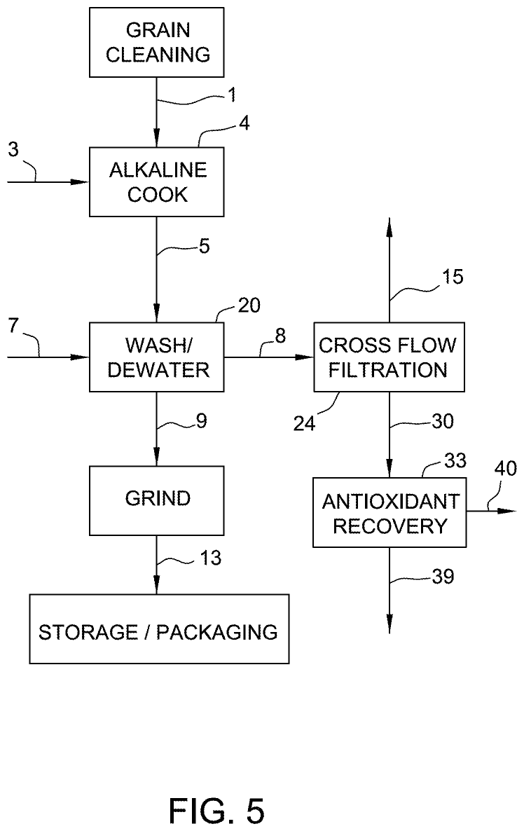

In some embodiments, an antioxidant composition is recovered from the permeate 15 and/or retentate 30 produced from the cross-flow filtration module 24. As shown in FIGS. 4 and 5, the wastewater effluent 8 produced as a by-product of the alkaline hydrolysis of the cereal grain 1 is introduced into a cross-flow filtration module 24 such as the cross-flow filtration membrane described above. At least one of the permeate 15 and retentate 30 is enriched in antioxidants relative to the effluent 8.

In the method of FIG. 4, the permeate 15 is introduced into an antioxidant recovery unit 33 to extract an antioxidant composition 40 from the permeate and produce an antioxidant depleted permeate 37. In the method of FIG. 5, the retentate 30 is introduced into the antioxidant recovery unit 33 to extract an antioxidant composition 40 from the retentate and produce an antioxidant depleted retentate 39.

Antioxidant compounds that may be recovered from the permeate 15 or retentate 30 include, but are not limited to, phenolic compounds, polyphenolics, ferulic acid, sinapinic acid, cinnamic acid, caffeic acid, chlorogenic acid, coumaric acid, vanillic acid, tocopherol, tocotrienols, anthocyanins, procyanidins, flavonoids, polyflavonols, tannins, and combinations thereof.

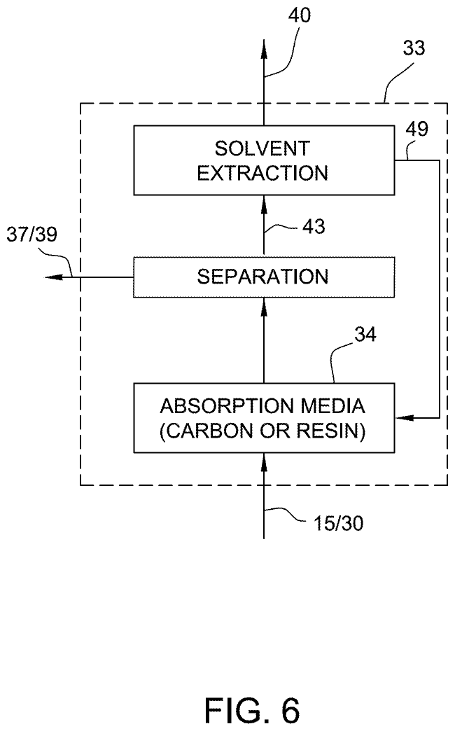

In some embodiments and as shown in FIG. 6, the permeate 15 or retentate 30 is contacted with absorption media 34 in the antioxidant recovery unit 33 to absorb antioxidant compounds onto the media. For example, the permeate 15 or retentate 30 may be contacted with activated carbon or resin to absorb antioxidants. The carbon or resin with absorbed antioxidants thereon may be separated (e.g., precipitation or centrifugation) to produce the antioxidant depleted permeate 37 or retentate 39. The antioxidants 40 may be desorbed from the separated carbon or resin 43 by contacting the carbon or resin with an organic solvent. The organic solvent may be evaporated to further separate and/or concentrate the antioxidants. Carbon or resin 49 may be recycled for use in further capture of antioxidants.

In other embodiments, absorption media is eliminated and the permeate 15 or retentate 30 is directly contacted with a solvent in the antioxidant recovery unit 33 to extract the antioxidant compounds. Suitable solvents include organic solvents such as ethyl acetate, ethyl lactate, isopropanol, ethanol, ether, pentanol, aliphatic alcohol, acetonitrile, hexane and combinations thereof. The permeate 15 or retentate 30 may be concentrated prior to solvent extraction such as by spray drying, freeze drying and/or evaporation.

In some embodiments, at least about 33% or more (e.g., 50%, 75%, 90%, 95% or more) of the antioxidant compounds introduced into the cross-flow filtration module 24 are recovered in the permeate 15 or retentate 30. Alternatively or in addition, the yield of antioxidants recovered from the wastewater effluent 8 may be about 0.1 grams of antioxidants per liter of wastewater effluent (e.g., 0.5 grams, 1 gram, or 1.5 grains or more of antioxidants per liter of wastewater effluent).

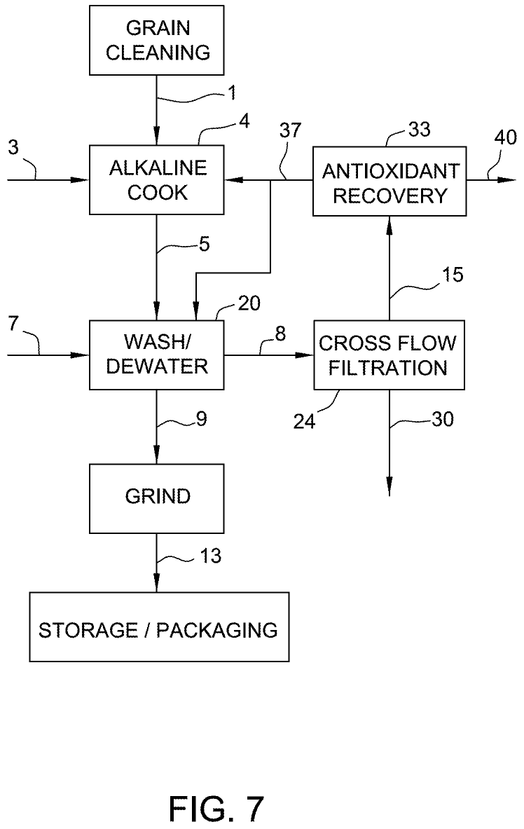

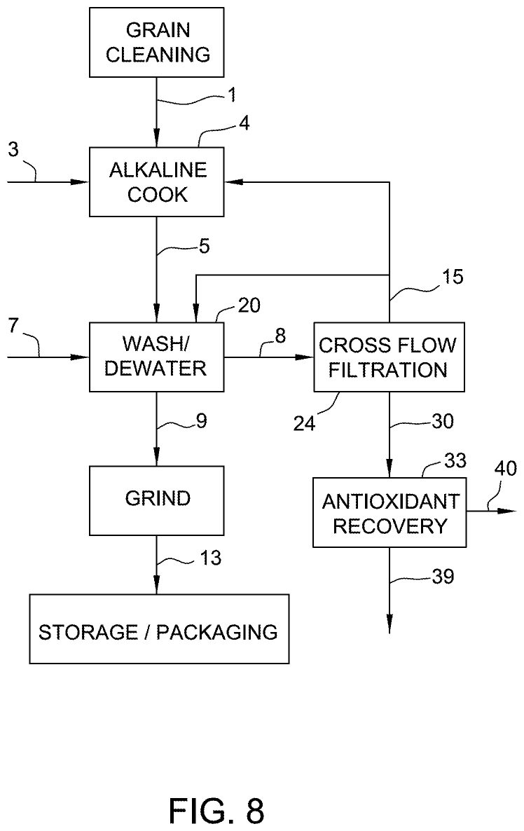

Referring now to FIG. 7, in embodiments in which antioxidants are recovered from the permeate 15, at least a portion of the antioxidant depleted permeate 37 may be recycled such as by introduction into the alkaline cooking system 4 or the dewatering system 20. In embodiments in which an antioxidant composition 40 is recovered from the retentate 30, a portion of the permeate 15 may also be recycled such as by introduction into the alkaline cooking system 4 or the dewatering system 20 (FIG. 8).

After storage and/or packaging, the antioxidant composition 40 may be processed for human and/or animal use (e.g., formulated in a food or drink, in a pharmaceutical, or in a cosmetic).

It should be noted that FIGS. 1-8 are exemplary and should not be considered in a limiting sense. The methods and/or systems for processing cereal grain to form a food product may include additional unit operations and/or unit operations may be reordered and/or eliminated unless stated otherwise.

Compared to conventional methods for producing a food product, the methods of the present disclosure have several advantages. For example, by using a cross-flow filtration membrane, fouling of the membrane may be reduced which increases the life of the membrane and reduces processing downtime. In embodiments in which at least a portion of the permeate is recycled such as by introduction in the alkaline cooking system or the dewatering system (e.g., for washing of cooked grain), the amount of process water input into the processing system may be reduced, the amount of alkaline (e.g., lime) used to hydrolyze the grain may be reduced (i.e., when recycling to the cooking system), and/or the heat in the recycled permeate may be recovered (e.g., by direct use of recycled permeate or by exchanging heat with other process streams). In embodiments in which a filtration membrane includes a stainless steel or nickel alloy substrate, the membrane is stable at the relatively high pH and relatively high temperature of the wastewater effluent. The stability of the membrane allows the wastewater effluent to be filtered without reducing the pH and/or temperature of the effluent. In embodiments in which an antioxidant composition (e.g., phenolics) is recovered from the permeate or retentate from the cross-flow filtration module, the antioxidant composition may be further processed for human or animal use which improves the economics of the food processing system.

### EXAMPLES

The processes of the present disclosure are further illustrated by the following Examples. These Examples should not be viewed in a limiting sense.

Batch and continuous filtration operations were tested during separate trials. Batch operation was used to determine the estimated volume recovery feasible for wastewater. Continuous operation was tested to determine efficacy of the membrane filtration over time. The combination of recovery volumes paired with flux value over time were used to estimate the size needed for handling the flow rate of alkaline cook water discharged from a macerator for various recovery amounts and feed rates.

### Example 1: Batch Testing to Determine Estimated Volume Recovery of Cook Water

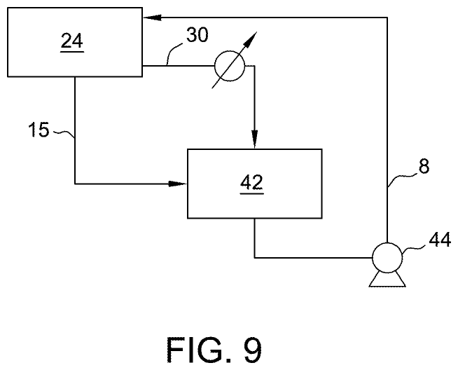

Alkaline cook water discharged through a macerator was sifted for large particles. The cook water (pH of 10.9-11.1) was processed through a cross-flow filtration module having a microfiltration membrane (benchtop model Scepter® filter from Graver Technologies (Glasgow, Del.)). The testing system (FIG. 9) included a feed tank 42 with cook water effluent 8 being fed by a feed pump 44 into a membrane module 24. The module 24 included six membrane tubes made of stainless steel (316L) coated with sintered titanium dioxide. The tubes were connected in series and enclosed in a permeate collection shell. Permeate 15 and retentate 30 were returned to the feed tank 42.

The test fluid was macerator effluent separated from the grain. The initial feed was a pale yellow color and completely opaque, with a cooked corn odor. Some suspended solids settled in the feed quickly, leaving a turbid supernatant. The feed was agitated in to re-disperse any settle solids. Material was then pre-heated to 60° C. using low-pressure steam in an immersion coil with all condensate sent to drain.

After the feed was transferred to a test unit, the temperature was increased and maintained at approximately 74° C. through the use of low-pressure steam through the shell side of a heat exchanger. Shortly after introduction to the test unit, feed color changed to a slightly green hue. All permeates were golden brown and crystal clear. Final concentrate was similar to the initial feed, but much more viscous.

Permeate and retentate were recycled to the tank for 47 minutes allowing the membrane to achieve steady state flux. A pressure scan was performed by incrementally increasing trans-membrane pressure (IMP), while holding all other parameters constant. Membrane flux briefly increased with TMP, but then dropped back to the prior recorded level. Lack of a permanent flux increase at higher TMP demonstrates that the membrane was diffusion-limited at the lowest TMP tested. A concentration scan was performed by incrementally removing permeate while recycling concentrate and holding all other parameters constant.

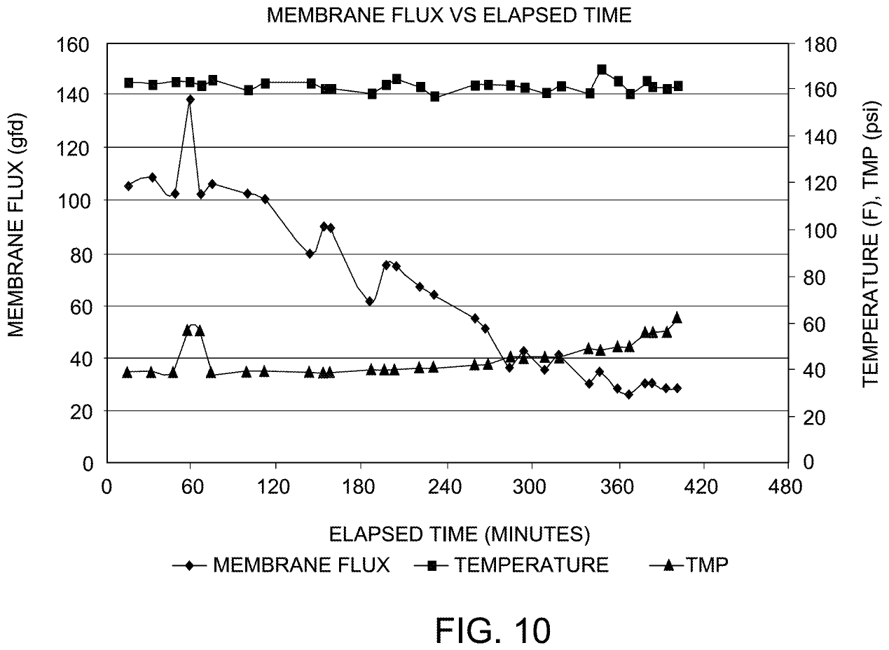

The test was stopped because the unit reached minimum volume. Given additional feed, the test could have continued to higher volume recovery. The membrane flux over time is shown in FIG. 10.

### Example 2: Continuous Testing to Determine Efficacy of Membrane Filtration Over Time

Alkaline cook water (pH of 10.7-11.2) discharged from a macerator was sifted for large particles and then processed through a cross-flow filtration module having a microfiltration membrane made of stainless steel coated with sintered titanium dioxide (Scepter® membrane). Continuous operation was performed to determine efficacy of the membrane filtration over time. The testing system (FIG. 11) included a feed tank 42 with cook water effluent 8 being fed by feed pump 44 into a set of four membrane modules 24. Retentate 30 was introduced to each module 24 in series and the permeate 15 from the modules 24 was collected.

The processed wastewater was macerator effluent with large particles such as corn kernels, large bran and germ being separated. Wastewater was circulated until steady state flux was achieved in the membrane. A target data point was taken to determine the membrane flux at the steady state prior to continuous operation.

For continuous operation, the permeate 15 and retentate 30 were directed to drain 50. Wastewater effluent 8 from the macerator was fed to tank 42. Every hour, the drain valves were closed and permeate/concentrate again recirculated back into the feed tank 42. After resting for 5 minutes on recirculation, another data point was collected to determine the flux. These data points are reported in Table 1, below.

Collected data indicated that 90% permeate recovery may be achieved with a membrane flux of 44.3 GFD. Reducing permeate recovery to 71.3% increased membrane flux to 70.1 GFD.

TABLE 1
Table 1: Membrane Flux for various permeate recovery amounts.

| Permeate Recovery (%) | Membrane Flux (GFD) |
|---|---|
| 90.0 | 44.3 |
| 88.5 | 48.2 |
| 85.6 | 54.1 |
| 82.2 | 59.4 |
| 73.5 | 68.4 |
| 71.3 | 70.1 |

### Example 3: Recovery of Antioxidants from Masa Wastewater

Antioxidants (phenolics) were recovered from masa wastewater by resin adsorption to demonstrate antioxidant recovery from the permeate or retentate discharged from a cross flow filtration module. The resins used for adsorption of phenolics were activated by contacting the resin (21 g) with ethanol (125 ml) in a beaker (250 ml) to cover the bed of resin by about 2.5-5 cm of ethanol. Alternatively, methanol could be used to activate the resin. The resin and ethanol were blended by shaking for 1 minute and the suspension was stirred at 175 rpm at 25° C. for 15 minutes. The beads (21 g) were filtered out of the mixture and were twice rinsed with deionized water (105 g) at a 5:1 mass ratio of deionized water to resin. The washed resins included about 65% water as determined by drying to constant weight (100° C. overnight).

Masa wastewater was adjusted from 12.4 pH to 4 pH by addition of 85% sulfuric acid. Hydrated activated resin was mixed with wastewater (3 g of resin to 25 ml wastewater or 21 g resin to 175 ml wastewater) in sealed Erlenmeyer flasks (25° C.). The mixture was mixed on an orbital shaker at 175 rpm for up to 3 hours. The beads of resin were filtered by a 0.45 μm membrane filter. The phenolic level in the masa wastewater was determined before and after contact with resin and indicated yields between 67-90%.

After adsorption, the resins were washed with distilled water to remove unadsorbed compounds that may reduce the purity of the extracts. The resin was washed twice with distilled water at a mass ratio of resin to water of 3:1. The mixture was mixed on an orbital shaker for 20 minutes at 25° C.

The washed resins (65% moisture) were contacted with an ethanol/water (88:12) solution (1 gram resin to 3 ml solution) at 25° C. to desorb extracts. Alternatively, acidified ethanol (0.5% w/w HCl 37%) may be used for desorption. The mixture was mixed for 2 hours on a rotary shaker at 180 rpm at 25° C. Resin was regenerated overnight in 1 M NaOH and was washed with deionized water.

The amount of antioxidants in the masa wastewater before extraction is shown in Table 2.

TABLE 2
Table 2: Amount of Antioxidants in Masa Wastewater.

| | Ferulic Acid | Gallic Acid Equivalent |
|---|---|---|
| | (ppm) | (mg/mL GAE) |
| First Sample of Wastewater | 683 | 1.2353 |
| Second Sample of Wastewater | 682 | 1.2116 |

Several different resins were tested for antioxidant recovery with the amount of antioxidants in the desorbed solution and the recovery rate being shown in Table 3.

TABLE 3
Table 3: Antioxidant Recovery from Masa Wastewater.

| | Ferulic | GAE | Total | Recovery |
|---|---|---|---|---|
| | Acid | (mg/ml | Ferulic | Rate |
| Sample | (ppm) | GAE) | Acids (mg) | (%) |
| HP 2MGL (Resindion Srl) | 5422 | 9.8552 | 108.44 | 90.82 |
| HP 20 (Resindion Srl) | 5275 | 9.319 | 105.50 | 88.36 |
| SP 700 (Resindion Srl) | 5642 | 11.7874 | 112.84 | 94.51 |
| SP 710 (Resindion Srl) | 5135 | 9.8238 | 102.70 | 86.01 |
| Amberlite XAD-4 | 5958 | 13.146 | 119.16 | 99.80 |
| (Rohm & Haas) | | | | |
| Amberlite XAD-7 | 5286 | 10.2695 | 105.72 | 88.54 |
| (Rohm & Haas) | | | | |
| Amberlite XAD-16 | 4802 | 7.6863 | 96.04 | 80.44 |
| (Rohm & Haas) | | | | |

As shown in Table 3, each adsorbent recovered 80% or more of the antioxidants with Amberlite XAD-4 recovering 99.8% of the antioxidants.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. A method for producing a food product from a cereal grain, the method comprising:
introducing the cereal grain into an alkaline cooking system to contact the cereal grain with an alkaline solution to partially hydrolyze the cereal grain;
dewatering the partially hydrolyzed cereal grain in a dewatering system to form a food precursor and a wastewater effluent;
processing the food precursor to form a food product;
introducing the wastewater effluent into a cross-flow filtration module to produce a permeate, the permeate being depleted in impurities relative to the effluent; and
introducing at least a portion of the permeate into (1) the alkaline cooking system for partially hydrolyzing the cereal grain and/or (2) the dewatering system.

2. The method as set forth in claim 1 wherein the dewatering system further comprises a washing system for washing the partially hydrolyzed cereal grain, at least a portion of the permeate being introduced into the washing system.

3. The method as set forth in claim 1 wherein:
the permeate is introduced into the alkaline cooking system for partially hydrolyzing the cereal grain;
the permeate is contacted with activated carbon or resin material to remove impurities from the permeate; and
the pH of the permeate is reduced to 9 or less prior to introducing the permeate into (1) the alkaline cooking system for partially hydrolyzing the cereal grain and/or (2) the dewatering system.

4-6. (canceled)

7. The method as set forth in claim 1 comprising extracting an antioxidant composition from the permeate or from a retentate produced from the cross-flow filtration module.

8. The method as set forth in claim 1 wherein the cross-flow filtration module includes a porous filtration membrane, the porous filtration membrane being stable at a pH of about 11.

9. The method as set forth in claim 1 wherein the cross-flow filtration module includes a porous filtration membrane comprising:
a substrate, the substrate being made of stainless steel or a nickel alloy; and
a sintered titanium dioxide coating bonded to the substrate.

10. (canceled)

11. The method as set forth in claim 1 wherein the wastewater effluent introduced into the cross-flow filtration module has a pH of at least about 10.5.

12. A method for recovering antioxidants from a wastewater effluent, the wastewater effluent being a by-product of the alkaline hydrolysis of a cereal grain, the method comprising:
introducing the wastewater effluent into a cross-flow filtration module, the cross-flow filtration module comprising a porous filtration membrane which retains a portion of the effluent as retentate and allows a portion of the effluent to pass through the filtration membrane as permeate, the retentate or permeate being enriched in antioxidants relative to the wastewater effluent; and
extracting the antioxidant compounds from the permeate or from the retentate.

13. The method as set forth in claim 12 wherein the porous filtration membrane is stable at a pH of about 11.

14-16. (canceled)

17. The method as set forth in claim 12 wherein the antioxidant compounds are selected from the group consisting of phenolic compounds, polyphenolics, ferulic acid, sinapinic acid, cinnamic acid, caffeic acid, chlorogenic acid, coumaric acid, vanillic acid, tocopherol, tocotrienols, anthocyanins, procyanidins, flavonoids, polyflavonols, tannins, and combinations thereof.

18-19. (canceled)

20. The method as set forth in claim 12 wherein the porous filtration membrane includes pores, the pores having an average diameter of from about 0.1 μm to about 10 μm and wherein the cross-flow filtration module is a multi-pass module.

21. (canceled)

22. The method as set forth in any claim 12 wherein the antioxidant compounds are extracted from the permeate or retentate by solvent extraction.

23. (canceled)

24. The method as set forth in claim 12 comprising concentrating the permeate or retentate by absorption, spray drying, freeze drying and/or evaporation to extract antioxidant compounds.

25. The method as set forth in claim 12 comprising contacting the permeate or retentate with absorption media to extract antioxidant compounds.

26. The method as set forth in claim 12 wherein the temperature of the wastewater effluent introduced into the cross-flow filtration module is at least about 40° C.

27. An antioxidant composition comprising the antioxidant compounds recovered by the method of claim 12.

28. A method for producing a food product and an antioxidant composition from a cereal grain, the method comprising:
contacting the cereal grain with an alkaline solution to partially hydrolyze the cereal grain;
dewatering the partially hydrolyzed cereal grain to form a food precursor and a wastewater effluent;
processing the food precursor to form a food product;
introducing the wastewater effluent into a filtration module to concentrate antioxidants in a permeate or retentate; and
recycling at least a portion of the permeate to produce the food product and the antioxidant composition.

29. The method as set forth in claim 28 wherein at least a portion of the permeate is recycled by introducing at least a portion of the permeate into (1) an alkaline cooking system for partially hydrolyzing the cereal grain and/or (2) a wash system for washing the partially hydrolyzed cereal grain.

30. The method as set forth in claim 28 comprising separating the wastewater effluent from the food precursor, the pH of the wastewater effluent not being modified between separation and introduction into the filtration module.

31. The method as set forth in claim 28 wherein the wastewater effluent is directly introduced into the filtration module after washing the partially hydrolyzed cereal grain.

32. (canceled)

33. The method as set forth in claim 28 further comprising extracting the antioxidant composition from the permeate or retentate.

34. The antioxidant composition produced by the method of claim 28.
